(19) United States
(12) Patent Application Publication
(10) Pub. No.: US 2021/0166513 A1
(43) Pub. Date: Jun. 3, 2021

(54) SECURE ENCLOSURE WITH PROGRAMMABLE SOFTWARE ENABLING CONNECTION TO A NETWORK AND/OR AN EXTERNAL MOBILE DEVICE

(71) Applicants: Cole CONNOLLY, New York, NY (US); Arya TABATABAI, New York, NY (US); Nic SCHOLZ, New York, NY (US)

(72) Inventors: Cole CONNOLLY, New York, NY (US); Arya TABATABAI, New York, NY (US); Nic SCHOLZ, New York, NY (US)

(21) Appl. No.: 17/069,716

(22) Filed: Oct. 13, 2020

Related U.S. Application Data
(60) Provisional application No. 62/913,629, filed on Oct. 10, 2019.

(51) Int. Cl. G07C 9/00; G06F 21/60; G06F 21/31

(52) U.S. Cl. CPC G07C 9/00912; G07C 9/00944; G07C 2009/00952; G06F 21/604; G06F 21/31; G07C 9/00817

(57) ABSTRACT

Disclosed is a secure enclosure such as a safe that may be used sequentially by multiply users that includes a programmed data processing unit and an input device for the user to input information to the data processing unit. The input device could be an SMS code, PIN or a biometric sensor such as, for example, a fingerprint scanner. The programmable software enables a user to input specific operating information for providing access to the enclosure, as well as enabling such user to input a code for another device such as a mobile device selected by this user. The mobile device could be any device that is external to the secure enclosure, and may include a mobile phone, tablet or other device conveying information to a user of the condition of the safe and its use.

### PRIOR APPLICATION

This application claims priority from U.S. Provisional Application Ser. No. 62/913,629 file Oct. 10, 2019, the descriptions sat such application are hereby incorporated by this reference.

### FIELD OF THE INVENTION

The present invention relates to an enclosure to secure items for later access that may comprise a safe with a data processing unit having software for programming multiple uses that enable access to a network to transmit information concerning conditions of the secure enclosure to a user.

### BACKGROUND OF THE INVENTION

Various attempts have been made to provide secure enclosures such as safes or locked drawers of a filing cabinet with controls pa riding information to a user. Such known devices are typically engineered for a particular purpose and may not readily be reconfigured for a different purpose. It is therefore an object of the present invention to provide such items as a secure safe that contain a data processing unit and software that can be programmable in order to enable multiple uses, such as a series of multiple users, each having secure access. One typical use of the present invention could, for example, be a plurality of secure encloses such as safes for hotel rooms, dormitories and the like that may be programmed to allow a series of users access to the operating condition for the safe by a mobile device.

### SUMMARY OF THE INVENTION

These and other objects, features and advantages of the present invention are provided by an enclosure to secure items for later access by a user that includes a data processing unit containing software, and an input device for the user to input information to the data processing unit. The input device could be an SMS code, PIN or a biometric sensor such as, for example, a fingerprint scanner. The programmable software enables a user to input specific operating information for providing access to the enclosure, as well as enabling such user to input a code for another device such as a mobile device selected by this user. The mobile device could be any device that is external to the secure enclosure, and may include a mobile phone, tablet or other device conveying information to a user.

The programmable software enables this user to connect the secure enclosure to a network transmission system to provide information to the external device upon entering specific operating information whenever the enclosure becomes subject to certain conditions generating input information to the data processing unit.

These conditions generating input information to the data processing unit may vary depending on the desired use, and in one embodiment of the present invention, such input information is generated whenever the secure enclosure is opened for access and/or whenever an incorrect specific operating information is entered into the input device. In addition the generated input information to the data processing unit may include whenever the enclosure is subject to a force or vibration. For example, the force could be detected as relatively constant indicating a drill sir the like is being used to gain access to the secure enclosure, or a more impacting force indicating a blunt instrument has struck the enclosure. In either case, information is provided to the user's external or mobile device indicating such an occurrence.

Another condition to signal notification to the current user would be a signal to the mobile device whenever a door providing access to the enclosure is not closed properly or whenever opened. Further, a master override may be provided to gain access to the enclosure, and use of the master override to gain access would also generate input information to the data processing unit to notify the user.

The programmable software additionally may generate the input information to the data processing unit by use of an accelerometer or the like indicating whenever the enclosure is displaced in location to, again, signal the user, or to signal the user under circumstances whenever access information for another is entered, or whenever the access information for the user is deleted.

In a notable form of the present invention, the secure enclosure is intended to be used by a plurality of serial users, and in this embodiment of the present invention, the programmable software enables the data processing unit to enable each user to input respective access information for providing access to the enclosure, and the programmable software enables each user as added to input a respective code for an external or mobile device selected by the particular user.

The enclosure may also include an internal lens and light system to enable an image of any object within the secure enclosure to produce a signal to the data processing unit whenever the respective access information entered by the current user is deleted and an object remains in the enclosure. Such a lens would preferably be a curved fisheye lens, and typically 185 degrees, and configured in many applications to scan the bottom of the enclosure only to, in this way, preserve the privacy of the user. This would enable, for example, a plurality of the enclosures to be installed in respective rooms temporarily acquired of a multi-unit dwelling, such as a hotel, dormitory and the like; and the programmable software enables the data processing unit to provide information to a user of the contents whenever the user ends access to the room and an object remains in the enclosure.

In a notable form of the present invention, the programmable software may enable a diffused image to be generated to provide privacy; or alternatively trained to capture specific images to recognize specific items such as a cash envelope, cash, jewelry or the like. The programmable software also enables the data processing unit additionally to receive a signal to secure locking of the enclosure whenever the current user ends access to the room and an object remains in the enclosure. And for such uses such as a hotel, or a college dormitory, a management control is provided by the programmable software tea enable the data processing unit to have audit capabilities showing all access and uses of the secure enclosure and provide a signal to an external object such as a tablet or mobile phone or a management computer; as well also to notify management through the control unit whenever events signaling notice to a user are generated, or other malfunctions such as tampering, movement and the like.

In another form of the present invention, the programmable software enables the data processing unit to receive operating information from several users, and in this way allow the enclosure to be shared by, for example, roommates or selected employees at a workplace. The programmable software can provide a notice to one user when another accesses the secure enclosure; or to provide a notice to an administrator to indicate which user has accessed the enclosure at what time. The administrator may also be able to restrict access of a particular user under certain circumstances, such as time of day; and require an image to be captured, when desired, such as before of after the enclosure is accessed. The administrator would also be able to require biometric identification for access in order to have a secure log to identify those gaining access. In this way, employees and the like can be monitored for access for such items as depositing cash or other valuables in the enclosure.

These and other objects, features and advantages of the present invention will become apparent from the following detailed descriptions made in conjunction with the attached drawings.

### THE DRAWINGS

FIG. 1 is a perspective view of a safe illustrating one embodiment of the present invention usable with a mobile device;

FIG. 2 is a side view thereof;

FIGS. 3A through 3D are more detailed drawings of the embodiment of the present invention illustrated in FIGS. 1 and 2;

### DESCRIPTION OF PREFERRED EMBODIMENT

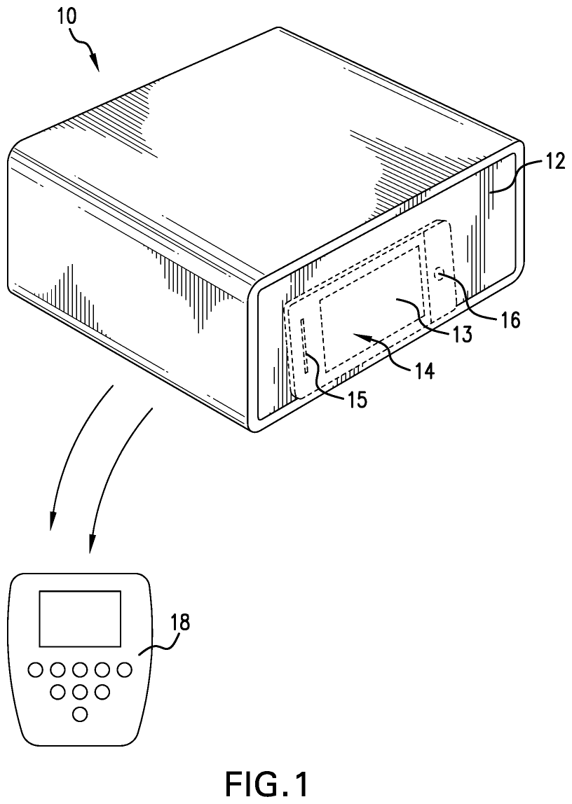

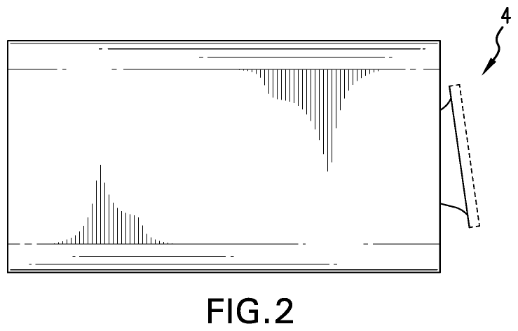

FIGS. 1 and 2 illustrate a safe 10 that forms one embodiment of the present invention. The safe 10 includes a door 12 to which is mounted a module 14. Module 14 includes an LED input screen 13 having a touch-screen display to input alpha-numeric information, and a bar 15 which can indicate by color code the operating conditions of the safe, such as door locked securely by, for example, a green LED, or door open or some other malfunction by a red LED. Also included are a biometric input 116 that may be a fingerprint sensor or other biometric sensor to allow access to the safe 10; or QR reader.

The safe, as will be described more fully below is able to communicate with a mobile device 18. As shown in FIG. 2, the module 14 is mounted to the door 12 and module 14 contains all the input devices and programmable software and data processing unit. In this way, the door 12 and module 14 that can be replaced as a unit if necessary while preserving the remainder of the safe structure.

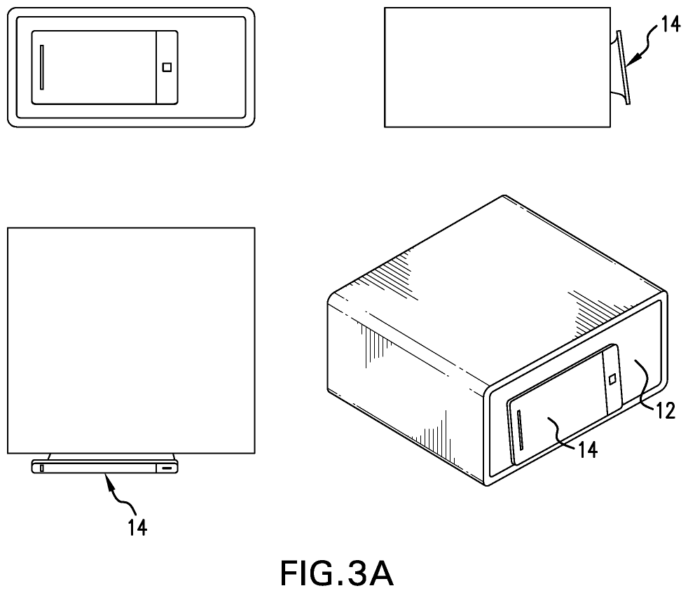

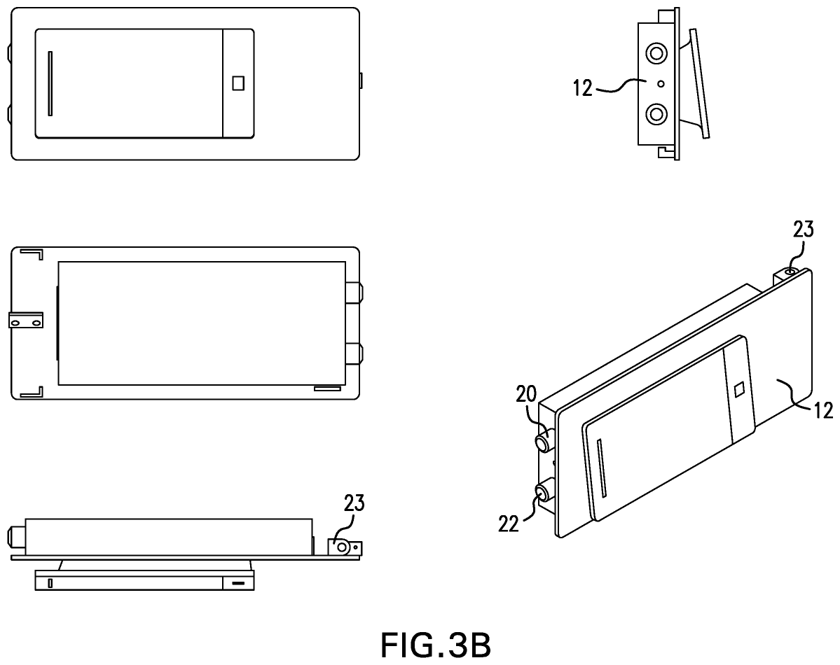

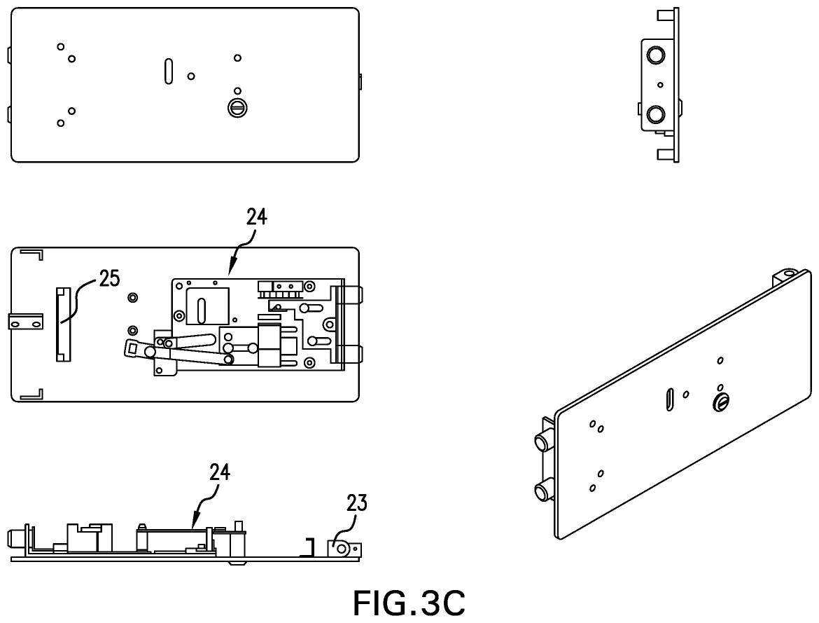

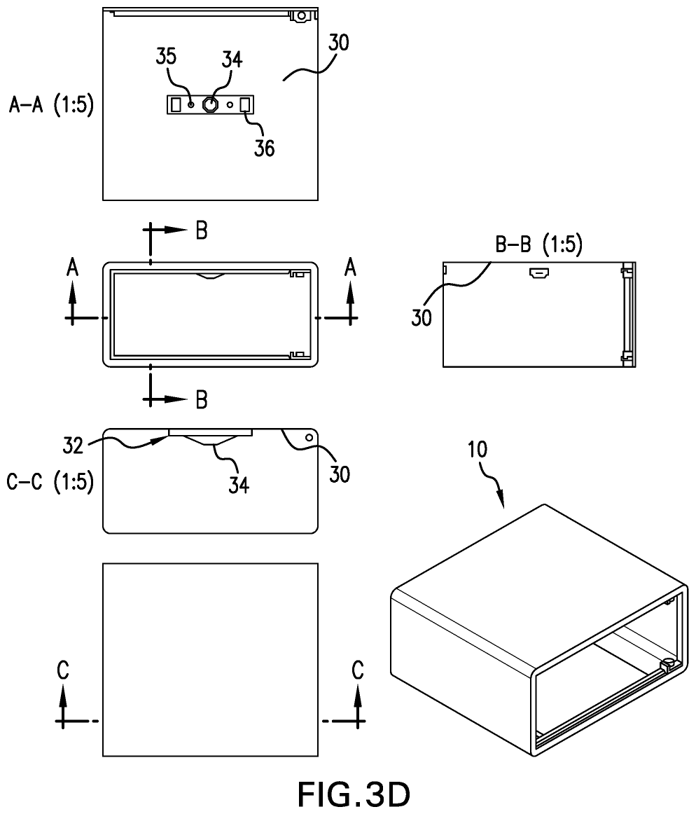

As shown in FIG. 3B, the door 12 has two locking dead bolts 20 and 22, actuated by the locking mechanism 24 shown in FIG. 3C; and drill-proof hinges 23.

FIG. 3D illustrates the interior of the safe 10, and includes an inner top surface 30 which includes a camera 32 with a fisheye lens 34, and LED lights 35 and 36. This internal lens and light system develops signals to the software to enable an image of any object within the safe 10 to be captured and provide information to the user whenever the specific operating information entered by the user is deleted and an object remains in the safe. Additionally, the software provides information to the mobile device selected by user whenever the specific operating information entered by the user is deleted and an object remains in the safe to warn the user.

In this way, a plurality of safes 10 can be installed in respective rooms temporarily acquired of a multi-unit facility, such as a hotel or dormitory, and provide information to the user whenever the user ends access to the room by, for example, checking out from the hotel, and an object remains in the safe. Further, whenever the safe is opened and an object is removed or placed in the safe, an image of the object can be captured and recorded to provide a record of all items placed in or with drawn from the safe. This would be particularly useful, for example, when the safe 10 is used in a business where several employees may need to have access to deposit or withdraw cash or other valuables. By the particular access code used to open the safe, the management would have a record of whom had accessed the safe and what items were placed in the safe or with drawn.

Further, the safe 10 preferably includes a motion detection device such as an accelerometer 25 to detect movement of the safe. In this way, the programable software can be used to sense a signal from the accelerometer when the safe is jostled or moved to provide information to the user the safe may be tampered with. The software can also detect from the accelerometer signal whether the signal is continuous indicating an attempt to drill into the safe to open the safe, or a short burst indicting impact such as when the safe may be struck by a hammer or the like to attempt to open.

The software is programmed to provide a signal to the user's mobile device 18 whenever a proper access code is generated to open the safe; or an incorrect access code is entered in an attempt to open the safe.

Flow diagrams of the programmable software of the preferred embodiment of the present invention follow.

What is claimed is:

1. An enclosure to secure items for later access by a user, said enclosure including a data processing unit containing software, and an input device for the user to input information; said data processing unit enabling:
(a) the user to input specific operating information for providing access to the enclosure, and
(b) the user to input a code for a mobile device selected by the user, said software able to connect the enclosure to a network transmission system to provide information to the mobile device selected by the user upon entering said specific operating information whenever the enclosure becomes subject to certain conditions generating input information to the data processing unit.

2. An enclosure to secure items for later access by a user as set forth in claim 1, said conditions generating input information to the data processing unit including whenever the enclosure is opened for access and, in addition, whenever an incorrect specific operating information is entered into the input device.

3. An enclosure to secure items for later access by a user as set forth in claim 2, said conditions generating input information to the data processing unit including whenever the enclosure is subject to an external force.

4. An enclosure to secure items for later access by a user as set forth in claim 3, said external force being a vibratory force.

5. An enclosure to secure items for later access by a user as set forth in claim 3, said external force being an impact force.

6. An intelligent secure enclosure adapted to be used by a plurality of serial users, said intelligent secure enclosure including a screen for illustrating information to the user, an input device for a user to input information, and programable software enabling:
(a) the user to input specific operating information for operating the safe, and
(b) the user to input an access code for a mobile device selected by the user, said software able to connect the intelligent secure enclosure to a network transmission system to provide information to the mobile device selected by the user upon entering said specific operating information whenever the intelligent secure enclosure is opened and whenever a incorrect specific operating information is entered into the input device; and
(c) the specific operating information entered may be deleted and the intelligent secure enclosure reset for the next user.

7. An intelligent secure enclosure adapted to be used by a plurality of serial users as set forth in claim 6, the intelligent secure enclosure including an internal lens and light system to enable an image of any object within the intelligent secure enclosure to produce a signal to said programable software, said programable software providing information to the user whenever the specific operating information entered by the user is deleted and an object remains in the intelligent secure enclosure.

8. An intelligent secure enclosure adapted to be used by a plurality of serial users as set forth in claim 7, said programable software providing information to the mobile device selected by user whenever the specific operating information entered by the user is deleted and an object remains in the intelligent secure enclosure.

9. An intelligent secure enclosure adapted to be used by a plurality of serial users as set forth in claim 6, the intelligent secure enclosure including an internal lens and light system to enable an image of any object within the intelligent secure enclosure to produce a signal to said programable software, a plurality of said intelligent secure enclosures being adapted to be installed in respective rooms temporarily acquired of a multi-unit facility, said programable software providing information to the user whenever the user ends access to the room and an object remains in the intelligent secure enclosure.

10. An intelligent secure enclosure adapted to be used by a plurality of serial users as set forth in claim 9, said programable software providing information to the mobile device selected by user whenever the user ends access to the room and an object remains in the intelligent secure enclosure.

11. An intelligent secure enclosure adapted to be used by a plurality of serial users as set forth in claim 9, said programable software additionally provides a signal to secure locking of the intelligent secure enclosure whenever the user ends access to the room and an object remains in the intelligent secure enclosure.

12. An intelligent secure enclosure adapted to be used by a plurality of serial users as set forth in claim 6, the intelligent secure enclosure including a motion detection device to detect movement of the intelligent secure enclosure, said programable software providing information to the user whenever movement of the intelligent secure enclosure is detected.

13. An intelligent secure enclosure adapted to be used by a plurality of serial users as set forth in claim 12, said programable software providing information to the mobile device selected by user whenever movement of the intelligent secure enclosure is detected.

14. An intelligent secure enclosure adapted to be used by a plurality of serial users as set forth in claim 6, the intelligent secure enclosure including a motion detection device to detect movement of the intelligent secure enclosure, a plurality of said intelligent secure enclosures being adapted to be installed in respective rooms temporarily acquired of a multi-unit facility, said programable software including a management control unit connected to said intelligent secure enclosures, said programable software providing information to the user and the management control unit whenever movement of the intelligent secure enclosure is detected.

15. An intelligent secure enclosure adapted to be used by a plurality of serial users as set forth in claim 14, said programable software providing information to the mobile device selected by user whenever movement of the intelligent secure enclosure is detected.

16. An intelligent secure enclosure adapted to be used by a plurality of serial users as set forth in claim 6, including a plurality of said intelligent secure enclosures being adapted to be installed in respective rooms temporarily acquired of a multi-unit facility, said programable software including a management control unit connected to said intelligent secure enclosures, said management control unit deleting the specific operating information whenever a user ends access to a room.

17. An intelligent secure enclosure adapted to be used by a plurality of serial users as set forth in claim 6, including a plurality of said intelligent secure enclosures being adapted to be installed in respective rooms temporarily acquired of a multi-unit facility, said programable software including a management control unit connected to said intelligent secure enclosures, said management control unit recording information to record a log for each opening and closing of each of the plurality of intelligent secure enclosures.

18. An intelligent secure enclosure adapted to be used by a plurality of serial users as set forth in claim 6, including a plurality of said intelligent secure enclosures being adapted to be installed in respective rooms temporarily acquired of a multi-unit facility, said programable software including a management control unit connected to said intelligent secure enclosures, said programable software enabling each of said intelligent secure enclosures installed in respective rooms temporarily acquired in a plurality of multi-unit facility being monitored at a central location.
